(19) United States
(12) Patent Application Publication
(10) Pub. No.: US 2010/0002815 A1
(43) Pub. Date: Jan. 7, 2010

(54) DYNAMIC FILTERING FOR ADJACENT CHANNEL INTERFERENCE SUPPRESSION

(75) Inventor: Hongbo Yan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/165,667

(22) Filed: Jul. 1, 2008

(51) Int. Cl. H04B 1/10

(52) U.S. Cl. 375/350; 455/307

(57) ABSTRACT

A method for adjacent channel interference suppression comprises the steps of receiving a composite signal including a signal of interest and possibly one or more adjacent channel interferers, measuring the signal of interest and the possibly one or more adjacent channel interferers, and adjusting a location of at least one dynamic filter to extract the signal of interest. A receiver apparatus comprises an antenna configured to receive a composite signal including a signal of interest and possibly one or more adjacent channel interferers, an interference measurement circuit configured to measure the signal of interest and the possibly one or more adjacent channel interferers, at least one dynamic filter configured to extract the signal of interest, and a processor configured to adjust a location of at least one dynamic filter to extract the signal of interest.

### BACKGROUND

1. Field

The present invention generally relates to interference suppression and, in particular, relates to dynamic filtering for adjacent channel interference (“ACI”) suppression.

2. Background

Many specifications for communication systems require a modem to possess a sufficient level of ACI suppression performance. As communication networks become even more densely deployed, the required ACI performance is ever increasing. Some approaches to implementing ACI suppression in a modem utilize static filters that may either attenuate too little of the interference, or undesirably attenuate part of the signal of interest.

### SUMMARY

The present invention solves the foregoing problems by providing a dynamic filtering approach to ACI suppression. The dynamic approach allows for optimal attenuation of interference while minimizing undesirable attenuation of a signal of interest.

According to one aspect of the subject technology, a method for ACI suppression comprises the steps of receiving a composite signal including a signal of interest and possibly one or more adjacent channel interferers, measuring the signal of interest and the possibly one or more adjacent channel interferers, and adjusting a location (a bandwidth and a position) of at least one dynamic filter to extract the signal of interest.

According to another aspect of the subject technology, a receiver apparatus comprises an antenna configured to receive a composite signal including a signal of interest and possibly one or more adjacent channel interferers, an interference measurement circuit configured to measure the signal of interest and the possibly one or more adjacent channel interferers, at least one dynamic filter configured to extract the signal of interest, and a processor configured to adjust a location of at least one dynamic filter to extract the signal of interest.

According to yet another aspect of the subject technology, a receiver apparatus comprises receiving means for receiving a composite signal including a signal of interest and possibly one or more adjacent channel interferers, measuring means for measuring the signal of interest and the possibly one or more adjacent channel interferers, dynamic filtering means for extracting the signal of interest, and processing means for adjusting a location of at least one dynamic filter to extract the signal of interest.

According to yet another aspect of the subject technology, a machine-readable medium comprises instructions for suppressing ACI. The instructions comprise code for receiving a composite signal including a signal of interest and possibly one or more adjacent channel interferers, measuring the signal of interest and the possibly one or more adjacent channel interferers, and adjusting a location of at least one dynamic filter to extract the signal of interest.

According to yet another aspect of the subject technology, a processor for suppressing ACI is configured to measure a signal of interest and possibly one or more adjacent channel interferers in a composite signal, and adjust a location of at least one dynamic filter to extract the signal of interest.

It is understood that other aspects of the subject technology will become readily apparent to those skilled in the art from the following detailed description, wherein various aspects of the subject technology are shown and described by way of illustration. As will be realized, the subject technology is capable of other and different aspects and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 illustrates an exemplary composite signal including a signal of interest and two adjacent channel interferers, according to one aspect of the subject technology;

FIG. 2 is a block diagram illustrating a receiver apparatus according to one aspect of the subject technology;

FIGS. 3A to 3C graphically illustrate the suppression of ACI, according to one aspect of the subject technology;

FIG. 4 is a block diagram illustrating a receiver apparatus according to one aspect of the subject technology;

FIGS. 5A and 5B graphically illustrate the suppression of ACI, according to one aspect of the subject technology;

FIG. 6 is a flow chart illustrating a method for ACI suppression, according to one aspect of the subject technology;

FIG. 7 is a block diagram illustrating a computer system with which certain aspects of the subject technology may be implemented.

### DETAILED DESCRIPTION

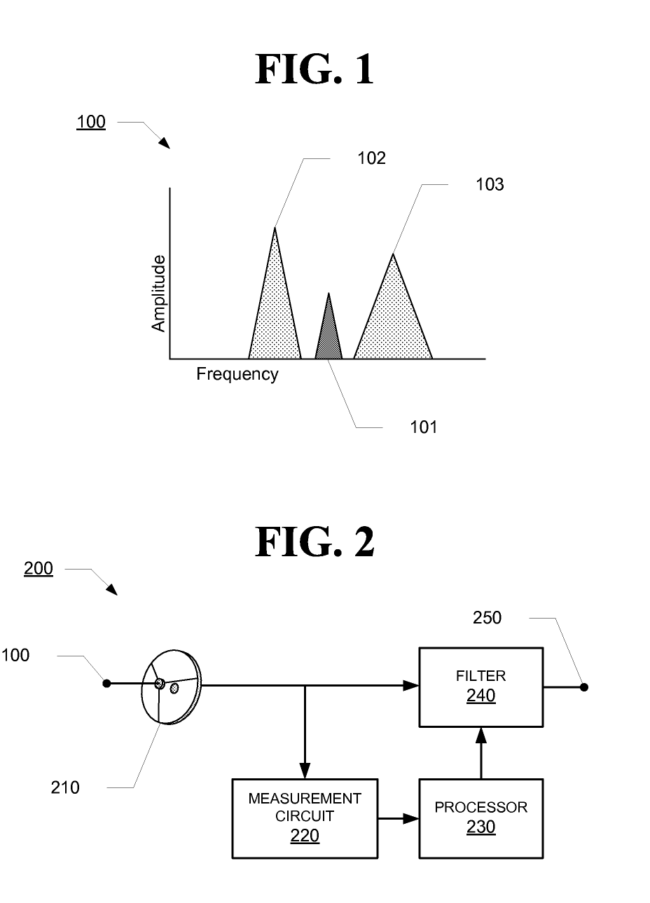

FIG. 1 illustrates an exemplary received signal according to one aspect of the subject technology. The composite signal 100 includes a signal of interest 101 and two adjacent channel interferers 102 and 103. Each adjacent channel interferer 102 and 103 has a bandwidth (represented by the width of the interferer along the horizontal frequency axis) and a position (e.g., a frequency at which the interferer is centered).

Some receivers may be designed with static filters for attenuating interference such as adjacent channel interferers 102 and 103. Using static filters, however, will sometimes attenuate over too small or too large a bandwidth (e.g., not fully attenuating the interferers, or undesirably attenuating part of the signal of interest). In addition, in an environment in which the interference may be dynamically changing, a static filter may only occasionally, if ever, optimally filter a received signal.

In accordance with one aspect of the subject technology, a receiver apparatus, such as is illustrated in FIG. 2, is provided with improved ACI suppression. Receiver apparatus 200 includes an antenna 210 configured to receive composite signal 100, and to provide composite signal 100 to a measurement circuit 220. According to another aspect of the present disclosure, measurement circuit 220 measures a strength and/or a location of a signal of interest 101 and of adjacent channel interferers 102 and 103, and provides information about the measurement to processor 230. Processor 230 receives the information and generates, in response, instructions for adjusting a dynamic filter 240 to correspond to the location of the measured adjacent channel interferers.

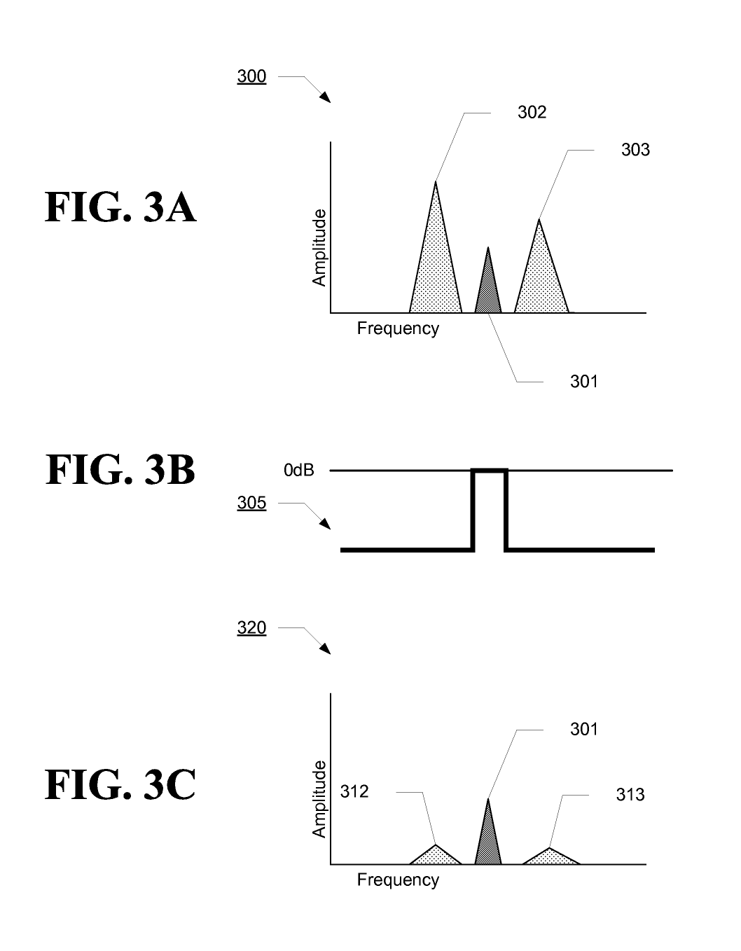

In accordance with one aspect of the subject technology, dynamic filter 240 may be a band-pass filter. In such an arrangement, dynamic filter 240 may be adjusted to align with the location of the signal of interest 101. (i.e., to pass only those frequencies of the signal of interest). Such an arrangement is illustrated in greater detail with respect to FIGS. 3A to 3C.

FIGS. 3A to 3C illustrate the performance of a dynamic band-pass filter in accordance with certain aspects of the present disclosure. FIG. 3A illustrates a composite signal 300 prior to filtering. Composite signal 300 includes a signal of interest 301 and two adjacent channel interferers 302 and 303. Accordingly, once the strength and the location of the signal of interest and of the adjacent channel interferers are measured, the processor configures a dynamic band-pass filter 305 to pass only those frequencies corresponding to signal of interest 301. The remaining frequencies, which include those of interferers 302 and 303, are attenuated by band-pass filter 305. The result of the attenuation can be seen in FIG. 3C. In filtered signal 320, the attenuated interferers 312 and 313 have dramatically less amplitude, thus greatly improving the signal-to-interference ratio (“SIR”) of filtered signal 320.

In accordance with another aspect of the subject technology, dynamic filter 240 may be a notch filter. In such an arrangement, dynamic notch filter 240 may be adjusted to have a notch corresponding to the location of an interferer.

While dynamic filter 240 is illustrated herein as a single block-level element, when dynamic filter 240 is a notch filter, it may comprise multiple dynamic notch filters, in accordance with various aspects. For example, for a signal such as signal 100, it may be desirable to have two dynamic notch filters, one for attenuating interferer 102, and one for attenuating interferer 103. In an aspect in which more adjacent channel interferers are present than dynamic notch filters are available, processor 230 may be configured to select which adjacent channel interferers to attenuate, and which not to attenuate, in order to achieve a best-possible SIR. Alternatively, a notch filter may be configured to have a wide enough bandwidth to attenuate multiple interferers (so long as no intermediate signal of interest is present between them).

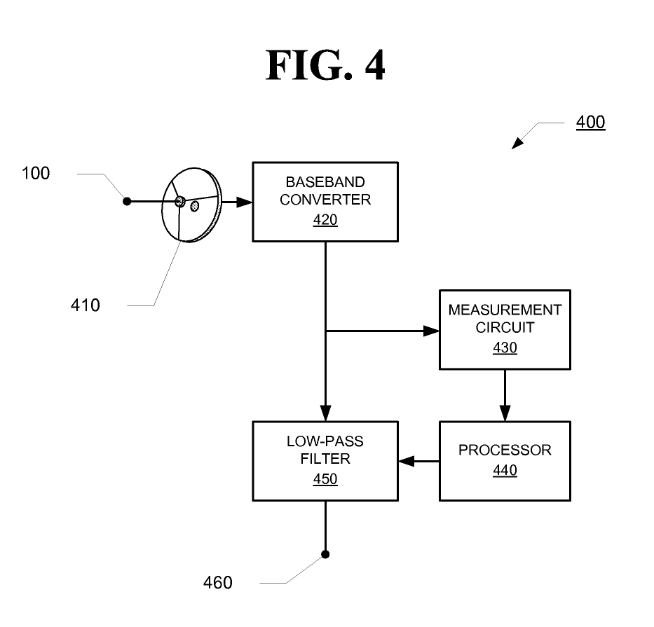

In accordance with another aspect of the subject technology, a dynamic filter may be a low-pass filter. Such an arrangement may be utilized in a receiver apparatus in which filtering takes place after baseband conversion. FIG. 4 illustrates one such receiver apparatus, in accordance with one aspect of the subject technology. Measurement circuit 430 measures a strength and a location of signal of interest 101 and of adjacent channel interferers 102 and 103 after they are converted to baseband, and provides information about the measurement to processor 440. Processor 440 receives the information and generates, in response, instructions for adjusting a dynamic low-pass filter (LPF) 450 to correspond to the relative strength and location of the measured signal of interest to the ACI.

According to one aspect of the subject technology, measurement circuit 430 may be configured to measure only the strength of signal of interest and of adjacent channel interferers 102 and 103. In this aspect, processor 440 is configured to adjust dynamic low-pass filter 450 corresponding to the relative strength of the signal of interest to the adjacent channel interferers 102 and 103. In this regard, if one detected ACI is strong, the bandwidth of low-pass filter 450 may be reduced on the side of the signal of interest on which the stronger ACI is present.

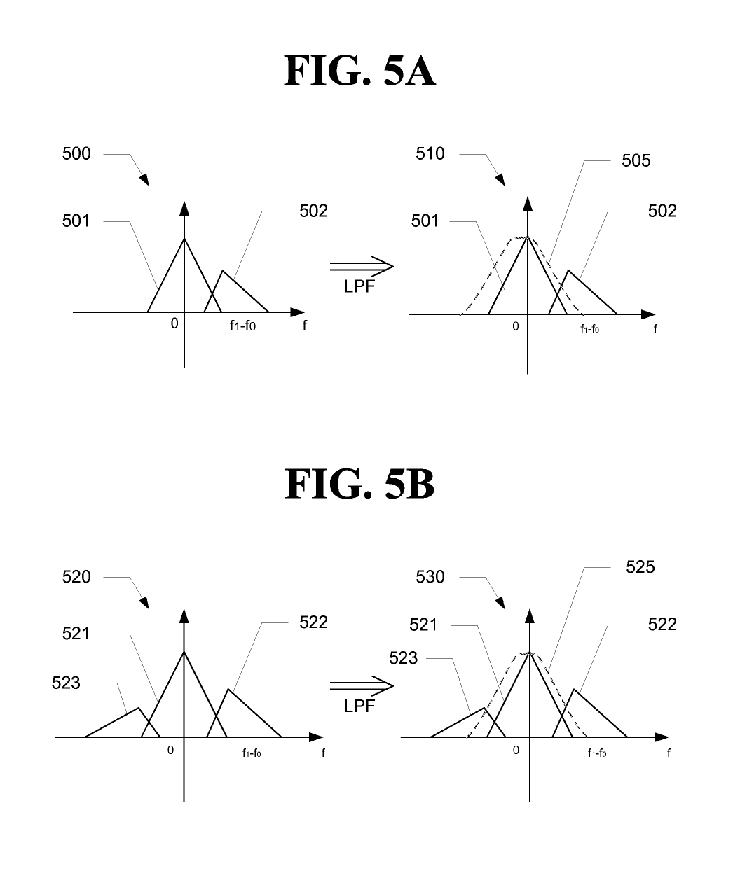

FIGS. 5A and 5B illustrate the performance of a dynamic low-pass filter in accordance with certain aspects of the present disclosure. FIG. 5A illustrates a received signal before 500 and after 510 low-pass filtering. Received signal 500 includes a signal of interest 501 and an adjacent channel interferer 502. Accordingly, once a strength and a location of signal of interest 501 and of ACI 502 are measured, the processor configures a dynamic low-pass filter 505 to extract signal of interest 501. Low-pass filter 505 is configured with enhanced attenuation on the right hand side of the filter, such that filter 505 is centered at a negative frequency.

FIG. 5B illustrates a received signal before 520 and after 530 low-pass filtering. Received signal 520 includes a signal of interest 521 and two adjacent channel interferers 522 and 523. ACI 522 is stronger than ACI 523. Accordingly, once a strength and a location of signal of interest 521 and of ACIs 522 and 523 are measured, the processor configures a dynamic low-pass filter 525 to extract signal of interest 521. Low-pass filter 525 is configured with enhanced attenuation on both sides, but with more greatly enhanced attenuation on the right hand side. As a result, filter 525 is centered at a negative frequency.

According to one exemplary aspect of the subject technology, an ACI strength measurement algorithm estimates signal power level P_{center} and ACI power levels P_{right} and P_{left} with filters centered at f_{center}, f_{right} and f_{left} Hz with a 3 dB bandwidth BW_{Det}. The suppression of ACI with a low-pass filter may then proceed according to the following logic:

```
if (P_{center}/P_{right} < Threshold and P_{center}/P_{leftt} > Threshold){
      Pass received signal through an LPF of reduced 3dB bandwidth on
the higher frequency side;
}
else if(P_{center}/P_{right} > Threshold and P_{center}/P_{leftt} < Threshold){
      Pass received signal through an LPF of reduced 3dB bandwidth on
the lower frequency side;
}
else (P_{center}/P_{right} < Threshold and P_{center} /P_{leftt} < Threshold){
      Pass received signal through an LPF of reduced 3dB bandwidth on
both sides;
}
```

While the measurement of signal of interest and of ACI has been described above with reference to particular algorithms, those of skill in the art will recognize that any one of a number of other methods may be used to measure signal of interest and ACI. Accordingly, the scope of the present invention is not limited to the particular arrangements for measuring signal of interest and ACI described herein, but rather encompasses any technique for measuring signal of interest and ACI known to those of skill in the art.

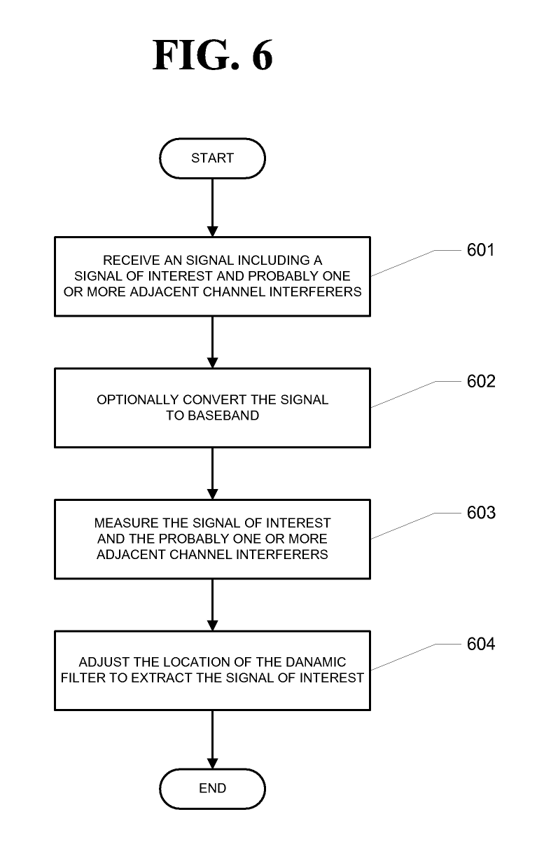

FIG. 6 is a flow chart illustrating a method for ACI suppression, according to one aspect of the subject technology. The method begins with step 601, in which a signal is received. The received signal includes a signal of interest and possibly one or more adjacent channel interferers. In step 602, the composite signal is optionally converted to baseband. In step 603, a strength and a location of the signal of interest and of the possibly one or more adjacent channel interferers are measured. In step 604, the location of a dynamic filter is adjusted to extract the signal of interest.

In accordance with one aspect, the measurement step 603 may include measuring only the strength of the signal of interest and of the possibly one or more adjacent channel interferers. In such an arrangement, the adjusting step 604 may include adjusting the location of the at least one dynamic filter corresponding to the measured strengths.

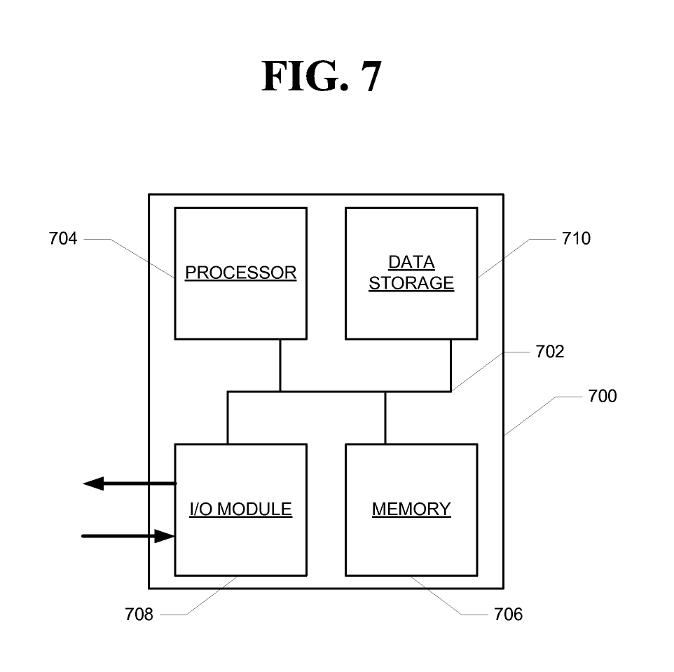

FIG. 7 is a block diagram that illustrates a computer system 700 upon which an aspect may be implemented. Computer system 700 includes a bus 702 or other communication mechanism for communicating information, and a processor 704 coupled with bus 702 for processing information. Computer system 700 also includes a memory 706, such as a random access memory (“RAM”) or other dynamic storage device, coupled to bus 702 for storing information and instructions to be executed by processor 704. Memory 706 may also be used for storing temporary variable or other intermediate information during execution of instructions to be executed by processor 704. Computer system 700 further includes a data storage device 710, such as a magnetic disk or optical disk, coupled to bus 702 for storing information and instructions.

Computer system 700 may be coupled via I/O module 708 to a display device (not illustrated), such as a cathode ray tube (“CRT”) or liquid crystal display (“LCD”) for displaying information to a computer user. An input device, such as, for example, a keyboard or a mouse may also be coupled to computer system 700 via I/O module 708 for communicating information and command selections to processor 704.

According to one aspect of the subject technology, ACI suppression is performed by a computer system 700 in response to processor 704 executing one or more sequences of one or more instructions contained in memory 706. Such instructions may be read into memory 706 from another machine-readable medium, such as data storage device 710. Execution of the sequences of instructions contained in main memory 706 causes processor 704 to perform the process steps described herein. One or more processors in a multi-processing arrangement may also be employed to execute the sequences of instructions contained in memory 706. In alternative aspects, hard-wired circuitry may be used in place of or in combination with software instructions to implement various aspects. Thus, aspects are not limited to any specific combination of hardware circuitry and software.

The term “machine-readable medium” as used herein refers to any medium that participates in providing instructions to processor 704 for execution. Such a medium may take many forms, including, but not limited to, non-volatile media, volatile media, and transmission media. Non-volatile media include, for example, optical or magnetic disks, such as data storage device 710. Volatile media include dynamic memory, such as memory 706. Transmission media include coaxial cables, copper wire, and fiber optics, including the wires that comprise bus 702. Transmission media can also take the form of acoustic or light waves, such as those generated during radio frequency and infrared data communications. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

Those of skill in the art would appreciate that the various illustrative blocks, modules, elements, components, methods, and algorithms described herein may be implemented as electronic hardware, computer software, or combinations of both. Furthermore, these may be partitioned differently than what is described. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application.

It is understood that the specific order or hierarchy of steps or blocks in the processes disclosed is an illustration of exemplary approaches. Based upon design preferences, it is understood that the specific order or hierarchy of steps or blocks in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for ACI suppression, comprising the steps of:
receiving a composite signal including a signal of interest and one or more adjacent channel interferers;
measuring a strength and/or a location of the signal of interest and the one or more adjacent channel interferers; and
adjusting a location of at least one dynamic filter to extract the signal of interest.

2. The method according to claim 1, wherein the at least one dynamic filter is a band-pass filter.

3. The method according to claim 2, wherein the adjusting the location of the at least one dynamic filter comprises adjusting the bandwidth and the center of the band-pass filter.

4. The method according to claim 1, further comprising converting the composite signal to intermediate frequency (“IF”).

5. The method according to claim 4, wherein the at least one dynamic filter is a band-pass filter.

6. The method according to claim 5, wherein the adjusting the location of the at least one dynamic filter comprises adjusting the bandwidth and the center of the band-pass filter.

7. The method according to claim 1, further comprising converting the composite signal to baseband.

8. The method according to claim 7, wherein the at least one dynamic filter is a low pass filter.

9. The method according to claim 8, wherein the adjusting the location of the at least one dynamic filter comprises adjusting the bandwidth and the center of the low pass filter.

10. The method according to claim 1, wherein the possibly one or more adjacent channel interferers comprises a first adjacent channel interferer having a first location and a second adjacent channel interferer having a second location, and wherein the first location is different than the second location.

11. The method according to claim 1, wherein the possibly one or more adjacent channel interferers comprises a first adjacent channel interferer having a first strength at a first location and a second adjacent channel interferer having a second strength at a second location, and wherein the first strength is different than the second strength.

12. The method according to claim 1, wherein the adjusting the location of the at least one dynamic filter comprises:
receiving, with a processor, information about the measurement of the signal of interest and of the possibly one or more adjacent channel interferers; and
generating instructions, with the processor, in response to the received information for adjusting the location of the at least one dynamic filter.

13. The method according to claim 1, wherein the measuring the signal of interest and the possibly one or more adjacent channel interferers comprises measuring a strength of the signal of interest and a strength of the one or more adjacent channel interferers.

14. The method according to claim 13, wherein the adjusting the location of the at least one dynamic filter comprises adjusting the location of the at least one dynamic filter to correspond to the strength of the signal of interest relative to the strength of the one or more adjacent channel interferers.

15. The method according to claim 13, wherein the measuring the signal of interest and the possibly one or more adjacent channel interferers further comprises measuring a location of the one or more adjacent channel interferers.

16. The method according to claim 15, wherein the adjusting the location of the at least one dynamic filter comprises adjusting the location of the at least one dynamic filter to correspond to the strength and the location of the signal of interest relative to the strength and the location of the one or more adjacent channel interferers.

17. A receiver apparatus, comprising:
an antenna configured to receive a composite signal including a signal of interest and one or more adjacent channel interferers;
an interference measurement circuit configured to measure a strength and/or a location of the signal of interest and of the one or more adjacent channel interferers;
at least one dynamic filter configured to extract the signal of interest; and
a processor configured to adjust a location of at least one dynamic filter based to extract the signal of interest.

18. The receiver apparatus according to claim 17, wherein the at least one dynamic filter is a band-pass filter.

19. The receiver apparatus according to claim 18, wherein the processor is configured to adjust the location of the band-pass filter.

20. The receiver apparatus according to claim 17, further comprising converting the composite signal to IF.

21. The receiver apparatus according to claim 20, wherein the at least one dynamic filter is a band-pass filter.

22. The receiver apparatus according to claim 21, wherein the processor is configured to adjust the location of the band-pass filter.

23. The receiver apparatus according to claim 17, further comprising a convertor configured to convert the composite signal to baseband.

24. The receiver apparatus according to claim 23, wherein the at least one dynamic filter is a low pass filter.

25. The receiver apparatus according to claim 24, wherein the processor is configured to adjust the location of the low pass filter.

26. The receiver apparatus according to claim 17, wherein the possibly one or more adjacent channel interferers comprises a first adjacent channel interferer having a first location and a second adjacent channel interferer having a second location, and wherein the first location is different than the second location.

27. The receiver apparatus according to claim 17, wherein the possibly one or more adjacent channel interferers comprises a first adjacent channel interferer having a first strength at a first location and a second adjacent channel interferer having a second strength at a second location, and wherein the first strength is different than the second strength.

28. The receiver apparatus according to claim 17, wherein the measurement circuit is further configured to measure a strength of the signal of interest and a strength of the possibly one or more adjacent channel interferers.

29. The receiver apparatus according to claim 28, wherein the processor is configured to adjust the location of the at least one dynamic filter to correspond to the strength of the signal of interest relative to the strength of the one or more adjacent channel interferers.

30. The receiver apparatus according to claim 28, wherein the measurement circuit is further configured to measure a location of the one or more adjacent channel interferers.

31. The receiver apparatus according to claim 30, wherein the processor is configured to adjust the location of the at least one dynamic filter to correspond to the strength and the location of the signal of interest relative to the strength and the location of the one or more adjacent channel interferers.

32. A machine-readable medium comprising instructions for suppressing ACI, the instructions comprising code for:
receiving a composite signal including a signal of interest and possibly one or more adjacent channel interferers;
measuring a strength and/or a location of the signal of interest and of the one or more adjacent channel interferers; and
adjusting a location of at least one dynamic filter to extract the signal of interest.

33. The machine-readable medium according to claim 32, wherein the instructions further comprise code for converting the composite signal to IF.

34. The machine-readable medium according to claim 32, wherein the instructions further comprise code for converting the composite signal to baseband.

33. The machine-readable medium according to claim 28, wherein the code for measuring the signal of interest and the possibly one or more adjacent channel interferers comprises code for measuring a strength of the signal of interest and a strength for the one or more adjacent channel interferers.

34. The machine-readable medium according to claim 28, wherein the code for adjusting the location of the at least one dynamic filter comprises code for adjusting the location of the at least one dynamic filter to correspond to the strength of the signal of interest relative to the strength of the one or more adjacent channel interferers.

35. The machine-readable medium according to claim 33, wherein the code for measuring the signal of interest and the one or more adjacent channel interferers further comprises code for measuring a location of the one or more adjacent channel interferers.

36. The machine-readable medium according to claim 30, wherein the code for adjusting the location of the at least one dynamic filter comprises code for adjusting the location of the at least one dynamic filter to correspond to the strength and the location of the signal of interest relative to the strength and the location of the one or more adjacent channel interferers.

37. A processor for suppressing ACI, the processor being configured to:
measure an strength of the signal of interest and an strength for the possibly one or more adjacent channel interferers; and
adjust the location of the at least one dynamic filter to correspond to the strength of the signal of interest relative to the strength of the one or more adjacent channel interferers.

39. The processor of claim 37, wherein the processor is further configured to:
measure a location for the one or more adjacent channel interferers; and
adjust the location of the at least one dynamic filter to correspond to the strength and the location of the signal of interest relative to the strength and the location of the one or more adjacent channel interferers.
